(19) United States
(12) Patent Application Publication
(10) Pub. No.: US 2011/0087557 A1
(43) Pub. Date: Apr. 14, 2011

(54) Method of selling each unit of manufacturer- packed cosmetic product in smaller portions at affordable prices

(76) Inventor: Tony Chuntat Yau, Hayward, CA (US)

(21) Appl. No.: 12/578,787

(22) Filed: Oct. 14, 2009

(51) Int. Cl. G06Q 50/00; G06Q 90/00; G06Q 30/00

(52) U.S. Cl. 705/26.5; 705/500

(57) ABSTRACT

A method for selling cosmetic products in a cosmetic bar is provided. The bar displays many cosmetic products, and various small volumes and shapes of small empty containers. Consumers can try testers in the bar, ask questions, and purchase their favorite cosmetic items in smaller portions rather than the whole manufacturer-packed unit by filling the order form provided. Based on consumers' requests, “bartenders” will transfer cream or fluid of desired cosmetic products from original manufacturer-packed containers to assigned small empty containers and finally, a pre-made label with name, image, main ingredients, volume and direction for use of the cosmetic product will be adhered onto its corresponding small cosmetic-filled container. The whole transferring process will meet the standard of sanitation to minimize contamination. No mixing of different cosmetic will be performed. The present invention will be advantageous to infrequent cosmetic users and consumers who like to try new cosmetic products.

### BACKGROUND OF THE INVENTION

1) Field of the Invention

The present invention relates to a method of selling manufacturer-packed cosmetic products, either online or in store, and more particularly, to a method of selling each unit of manufacturer-packed cosmetic product in smaller portions, either online or in store, at affordable prices by transferring cream or fluid of desired cosmetic products from original manufacturer-packed containers to selected small empty containers and selling them at more affordable prices.

2) Discussion of the Related Art

There are many methods for selling cosmetic products to attract consumers. The traditional methods for selling cosmetic products consist of the following steps:

According to my observation, all cosmetic retailers, either online or in-store, sell cosmetic products in units which are packed by manufacturers. They also display cosmetic products organized by brand names. Once a while, they release some coupons or gifts to increase consumers' spending desires. Attempting to attract more consumers, many cosmetic retailers provide testers in-store and hire beauty advisers to answer beauty questions.

However, infrequent cosmetic users and consumers who like to try new cosmetic products are limited to these traditional methods. A description will be described in detail on the limitations for consumers under traditional methods of selling cosmetic products.

The method of providing testers in-store can give consumers more confidence buying new cosmetic products, especially after having good impressions from trying the testers. According to the reference from Smith, Michael, skin reactions may occur within minutes or hours of exposure for strong irritants, such as those in perfumes and preservatives found in many beauty products. However, most cosmetic products usually take at least a few hours to start reacting or multiple applications on the skin before showing any noticeable results; some cosmetic products even take longer time and more applications to produce results.^{1,4} While trying testers in-store, consumers have not given those products enough time to react and thus could not detect their efficacy and results right away, same goes with their allergic reactions and side effects. I conclude that time is the best indicator for detecting the type of reactions that consumers may have to cosmetic products. If consumers purchased new brand names of cosmetic products for trial use but did not feel that the cosmetic products are efficacious enough after using them for a few days or weeks, or even worse, they experienced unwanted adverse effects, they would have stopped using those cosmetic products, ended up wasting money, resources and also produced more trash to the environment.

Furthermore, knowing cosmetic products are luxury goods and the problem above, consumers usually feel hesitated to purchase new cosmetic products even though they have tried the testers in the store. They are afraid of wasting those expensive cosmetic products but even more, afraid of wearing those which cause them irritation or non-effectiveness. As the result, the actions of which consumers actually buy new cosmetic products remain low under the traditional selling cosmetic method.

Practical data has shown that using different kinds of cosmetic products from different brand names are more efficacious than using those from same brand name. “Mixing and matching” is the only way to go.⁴

Beautician also said that our skin can get used to the cosmetic products we use and they would not seem as effective as before after awhile. Thereby, rotating new cosmetic products occasionally could have unexpected good results.³

However, [0007] and [0008] cannot be easily achieved under traditional method of selling cosmetic products. Consumers do not know which new cosmetic products would suit their needs while planning to try other new cosmetic products. All they can do is asking friends or beauticians for advices, and reading magazine reviews or blogs. However, everyone is bio-chemically difference. Each of us has a unique skin type and allergic reactions, which is why we can react so differently when exposed to the same thing.⁴ Thus, with the vast amount of choices available in the market, the risks of selecting unsuitable cosmetic products are really high. If consumers purchased the wrong products and were not satisfied with the results, they would be wasting money and either throw the unsuitable ones away and try other products, or spend a long time to finish the unsuitable ones before trying other products.

Natural cosmetic products are made from natural resources such as plants, roots, herbs and minerals.² Therefore, wasting cosmetic products is the same as wasting natural resources. However, consumers care about their skin and health more and do not have a choice but waste the cosmetic products which do not suit them. Time passes on, those natural resources which are used to manufacture cosmetic products become rare and additional steps to renew and recycle natural resources are required, thus the costs of producing cosmetic products will be higher.

According to the problems above, both manufacturers and retailers attempt to solve them as follows;

Manufacturers will mail free samples to households or sent those to retailers for distribution to promote a new cosmetic product. They wish that consumers would detect the reactions after trying free samples for days or weeks. However, this solution can only work on cosmetic products with strong efficacy and irritants. For those with weak efficacy and irritants, consumers not only need to take days or weeks to start detecting some reactions, but they also need to use multiple applications on the skin before symptoms appear.¹ Moreover, each free sample is usually packed in small amount and does not have enough doses for consumers to use multiple applications on the skin before symptoms appear.

Retailers hire many beauty advisers to help consumers pick their best fit products, but beauty advisers can only give broad suggestions on cosmetic products.⁴ It is truly impossible to know if, when, or how anyone's skin will react to any cosmetic unless consumers experiment those products themselves for a period of time.⁴

### SUMMARY OF THE INVENTION

The present invention has been advised to solve all those problems stated above; it is an objective of the present invention to provide a business selling method in cosmetic industry which benefits consumers. More specifically, the present invention applies to a business method of selling each unit of manufacturer-packed cosmetic product in smaller portions, either selling online or in store, at affordable prices to increase flexibility for consumers to try new products, to reduce environmental wastes and product returns, and thereby to provide an improvement on existing selling method in cosmetic field.

Indeed, traditional services of providing testers and beauty advices are remained and acted as extra services for the present invention.

In the present invention, consumers can purchase desired cosmetic product in smaller portions. Even if they are not satisfied and stopped using the cosmetic product afterward, consumers would have spent less money and produced less wastes than they would have from purchasing whole unit of manufacturer-packed product. It is thus an objective of this invention to save resources and consumers' money.

According to the aspect of the present invention, trying different products from different brand names and rotating new cosmetic products are no longer costly and time consuming. Consumers can buy each unit of manufacturer-packed cosmetic product in smaller portions, by transferring cream or fluid of desired cosmetic products from original manufacturer-packed containers to selected small empty containers. The retail price of a small cosmetic-filled container is proportional to the retail price of its corresponding manufacturer-packed cosmetic product. In this case, consumers who wish to try new cosmetic product can purchase smaller volume of that product at an affordable price so that they can avoid wasting too much money and resources even though they might end up unsatisfied with the products. Once they have found their best fit ones, they can purchase the full unit of cosmetic products. It is therefore an objective of this invention for consumers to spend less money and time on trying new cosmetic products.

As I have mentioned previously, time is the best indicator to detect cosmetic reactions. According to the aspects of this present invention, consumers can purchase a few days or weeks supply of desired cosmetic products until they are firmly sure that those cosmetic products work for them.

Furthermore, the present invention gives benefits to infrequent cosmetic users. A study states that regular opened cosmetic product can last approximately three months to three years. E.g. concealer—12 months, blush—6 months, eye shadow—12-14 months, mascara—3 months.⁶ Products that have positive effects on our skin contain active ingredients or have a limited shelf life which means they do degrade and lose their potency over time.³

However, it is difficult for an infrequent cosmetic user to finish up a unit of cosmetic product before it degrades and loses its potency. Even though they can fully use up the cosmetic products before the expiration date, they might not always be able to enjoy “best quality” cosmetic because the stability, and thus efficacy, of cosmetic products which have been opened for one year is comparatively worse than those which have been opened for only a month.

With this present invention, each unit of manufacturer-packed cosmetic product in the cosmetic bar is shared by many consumers. Those infrequent cosmetic users can purchase cosmetic products in smaller portion based on their needs. It is thus another objective of this invention to guarantee infrequent cosmetic users to enjoy “best quality” cosmetic products.

To avoid of wasting natural resources is the main goal for everyone. In the present invention, the amount of wasted cosmetic products will be decreased rapidly. Although many small empty containers will be used, the cost of wasted small empty containers is trivial compared to the cost of wasted cosmetic products. Furthermore, there are a few recycling strategies to minimize the waste in small empty containers including use of empty recyclable containers, cooperate with recycling companies and provide extra discounts on next purchases for returning consumers who recycle their used containers.

In the present invention, consumers will have more flexibility and feel less hesitated to try new cosmetic products than before. They will also be able to discover their best fit products much easier and faster. Furthermore, one of the main goals of the present invention is to decrease the chances of which people waste resources, and thereby to decrease chemical wastes in the earth.

### BRIEF DESCRIPTION OF THE DRAWING

FIG. 1 is an explanatory view of the principle of the present invention, a structure of the cosmetic bar to sell each unit of original manufacturer-packed cosmetic product in smaller portions to consumers.

FIG. 2 shows the process of transferring cream or fluid of desired cosmetic products from original manufacturer-packed containers to assigned small empty containers.

FIG. 3 is an order form for consumers to mark each cosmetic product with selected volume and shape of small empty container they would like to purchase.

FIG. 4 is the illustration of a pre-made label with name, image, main ingredients, volume and direction for use of the cosmetic product on it.

FIG. 5 is an explanatory view of the present invention applied online.

FIG. 6 is the illustration of various shapes of small empty containers to be selected.

### DETAILED DESCRIPTION OF THE EMBODIMENT

Reference will now be made in detail to the preferred embodiment of the invention, an example of which is illustrated in the accompanying drawings.

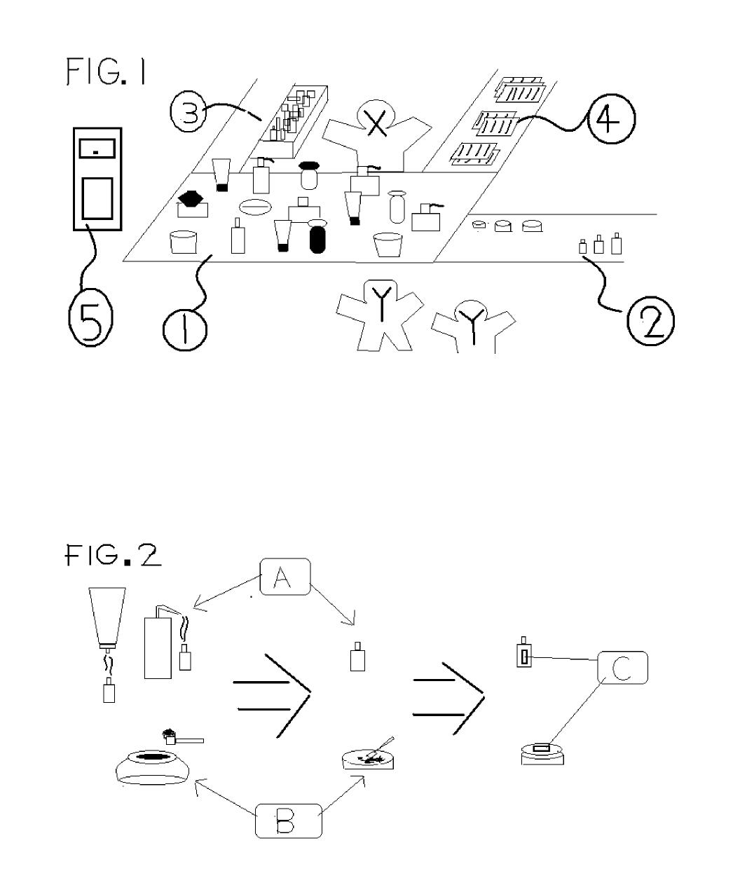

FIG. 1 is an explanatory view of the principle of the present invention. X represents the “bartender”, who is familiar with cosmetic goods and able to provide beauty advices and product recommendations to consumers. Y represents consumers, and numbers 1 to 5 are the process of the present invention.

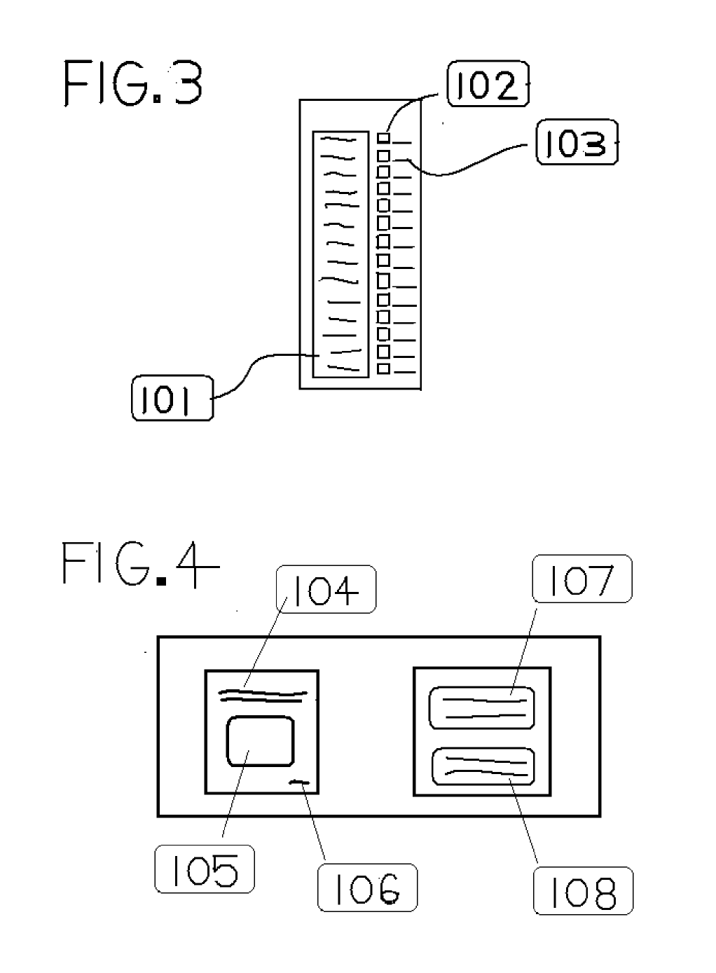

In the present invention, a cosmetic bar is set up (FIG. 1) and many different kinds of cosmetic products, organized by brand names, are displayed in front of consumers (Number 1). First, consumers can pick any cosmetic products on the bar, then they are required to choose one small empty container per each selected cosmetic product among various volumes and shapes of small empty containers (Number 2). The volumes of small empty containers are increment which goes up from 5 g (ml) to 50 g (ml) in every 5 g (ml) and the shapes of small empty containers are mainly, but not limited to, in squeezable tube-like shaped bottle, cylinder shaped bottle with a pump, pen shaped atomizer bottle, jar, etc (FIG. 6). Moreover, the retail price of a small cosmetic-filled container is proportional to the retail price of its corresponding manufacturer-packed cosmetic product. For example, the retail price of a 100 g manufacturer-packed cosmetic product is $50. If a consumer chooses a 5 g container to fill that product, all he needs to pay is $50/100 g×5 g=$2.5; 10 g container will be $5. Next, consumers are required to mark every cosmetic product with selected volume and shape of small empty container they desire to purchase on an order form (FIG. 3). Then, bartender reviews the order form carefully and fills them appropriately by transferring cream or fluid of desired cosmetic products from original manufacturer-packed containers to selected small empty containers on a designated filling table (Number 3). All new, clean small empty containers are placed under the filling table. Last, bartender carefully matches each pre-made label (FIG. 4) with its corresponding manufacturer-packed cosmetic product and sticks it onto the corresponding small cosmetic-filled container (Number 4). (Number 5) is a recycle bin to collect used small containers, returning consumers can bring their used small containers back to the store for extra discounts on next purchases. The traditional services of providing testers and beauty advices are remained and acted as extra services for the present invention.

FIG. 2 is the process of transferring cream or fluid of desired cosmetic products from original manufacturer-packed containers to assigned small empty containers.

Step A in FIG. 2 is the transferring process, all cream or fluid in original manufacturer-packed cosmetic containers will be transferred to assigned small empty containers without physically touching those cream or fluid to maintain their integrity. For cosmetic product with a pump or in a squeezable container, we will transfer the cream or fluid directly to a small empty container. For some cosmetic products which cannot be transferred directly to a small empty container, clean spoon will be used to assist the transfer process (Step B). The whole transferring process will meet the standard of sanitation to minimize contamination and maintain the integrity of the cosmetic products. All employees must wash their hands and wear gloves prior to the transferring procedure. No mixing of different cosmetic products will be performed. Finally, a small cosmetic-filled container is capped and labeled with the product's name, image, main ingredients, volume and direction for use of the cosmetic product (step C).

FIG. 3 is an order form for consumers. They can mark each cosmetic product with selected volume and shape of small empty container they would like to purchase. In the first column, many names of cosmetic products are clearly listed by brand names (101). When a consumer wishes to purchase a cosmetic product, s/he has to mark the box next to the name of the product (102), and then select the volume and shape of small empty container they wish to be used to fill its desired cosmetic product (103). The purpose of this table is to reduce confusion and avoid making any unnecessary mistake.

FIG. 4 is the illustration of a pre-made label with name, image, main ingredients, volume and direction for use of a cosmetic product on it. The name, image, volume, main ingredients and direction of use of the cosmetic product are placed at (104), (105), (106), (107), and (108) respectively. Labels for each cosmetic product are designed and then printed out in advance. Bartender will match each label with its corresponding cosmetic product and adhere it onto the corresponding small cosmetic-filled container.

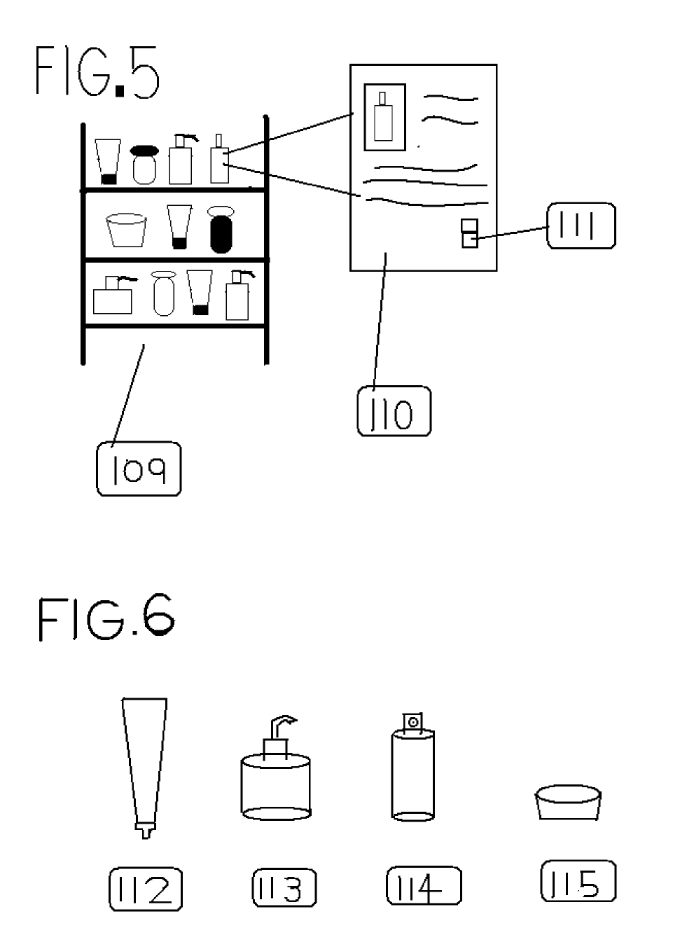

FIG. 5 is an explanatory view of the present invention applied online. Its selling method is the same as that in FIG. 1 except it is not providing testers and beauty advices.

(109) is a virtual cosmetic bar online, pictures of cosmetic products are listed by brand names in a virtual cosmetic bar and consumers can view the detail of each product by double-clicking on the image.

(110) is the page which shows the detail of a cosmetic product. The detail of the product includes images, description, main ingredients, and check out section.

(111) is the quantity box in check out section which has an option for consumers to select of which volume and shape of small empty container will be filled. For example, 5 g (ml) tube-like shaped container, 10 g (ml) atomizer container, and 50 g (ml) jar, etc.

After the order is confirmed and checked out, vendor will proceed to step 3 and step 4 in FIG. 1, and mail the final goods to consumer.

FIG. 6 is the illustration of various shapes of small empty containers to be selected. All small empty containers provided are recyclable and their shapes are mainly, but not limited to, in squeezable tube-like shaped bottle (112), cylinder shaped bottle with a pump (113), pen shaped atomizer bottle (114) or jar (115), etc.

Under the present invention, buying cosmetic products will become cheaper and more flexible than before. Consumers not only can try testers in-store, but also can purchase smaller portions of their favorite products for further trial. Thus, this present invention will provide a big improvement on existing cosmetic retail field.

### REFERENCE CITED

1. Smith, Michael. “Allergies and Cosmetics.” Cosmetic Allergy Reactions (Dermatitis caused by cosmetic allergies). 1 Nov. 2006. MedicineNet.com, Web. 20 Sep. 2009. <http://www.medicinenet.com/cosmetic_allergies/article.htm>
2. “Natural Cosmetic Products.” Natural Cosmetic Products. n.d. ClearLead Inc, Web. 15 Sep. 2009. <http://www.clearleadinc.com/site/natural-cosmetic.html>.
3. Sesame. “Do we need to rotate skin care products?.” Why skin care products become less effective overtime?. 16 Mar. 2009. Viva Woman, Web. 1 Aug. 2009. <http://www.vivawoman.net/2009/03/16/do-we-need-to-rotate-skin-care-products/>.
4. Begoun, Paula. The Beauty Bibble: The Ultimate Guide to Smart Beauty. 2nd ed. Renton, Wash.: Beginning Press, 2002. Print.
5. “Spring Skin Care Tips.” Spring Skin Care. n.d. SkinCare, Web. 5 Sep. 2009. <www.skincarecompany.net/spring-skin-care.htm>.
6. “Did You Know Your Cosmetics Have a Shelf Life?.” Shelf Life of Cosmetics. n.d. Natural Living for Women, Web. 5 Sep. 2009. <http://www.natural-living-for-women.com/shelf-life.html>.

What is claimed is:

1. A business method for selling each unit of manufacturer-packed cosmetic product in smaller portions at affordable prices, comprising the steps of:
Consumer marks every desired cosmetic product with selected volume and shape of small empty container on an order form.
Bartender reviews the order form and transfers cream or fluid of desired cosmetic products from original manufacturer-packed containers to assigned small empty containers.
Bartender matches each pre-made label with its corresponding manufacturer-packed cosmetic product and sticks it onto the corresponding small cosmetic-filled container.

2. The method of claim 1, further comprising:
The business selling cosmetic method is applied to both online and in-store.

3. The method of claim 1, further comprising:
Manufacturer-packed cosmetic product refers to cosmetic product which is original (first-time) packed by the one manufactures.

4. The method of claim 1, further comprising:
Selling in smaller portions refers to selling any volume of cosmetic-filled containers smaller than the volume of their corresponding original manufacturer-packed cosmetic products through the process of transferring cream or fluid of cosmetic products from original manufacturer-packed containers to small empty containers.

5. The method of claim 1, in which the step of marking every desired cosmetic product with selected volume and shape of small empty container on an order form comprises:
Consumers choose one small empty container per each selected manufacturer-packed cosmetic product among various volumes and shapes of small empty containers.
